(19) United States
(12) Patent Application Publication
(10) Pub. No.: US 2005/0102571 A1
(43) Pub. Date: May 12, 2005

(54) Reliability assessment system and method

(76) Inventors: Kuo-Juei Peng, Feng-Shan City (TW); Piao-Chou Tsao, Bade City (TW); Ming-Yuan Tsai, Sinshe Township (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/699,407

(22) Filed: Oct. 31, 2003

(51) Int. Cl. G06F 11/00

(52) U.S. Cl. 714/26

(57) ABSTRACT

A reliability assessment system. The system includes an interface and an assessment engine. The interface is a web-based interface, providing online reliability assessment. The system receives input items through the interface. The assessment engine performs the reliability assessment accordingly, generating and displaying the result on the interface.

### BACKGROUND

The present invention relates to a reliability assessment system and method, and particularly to a web-based reliability assessment system and method for online simulation and assessment of the reliability of services or products.

In client relations management, service suppliers, or manufacturers are required to provide information regarding product reliability. Currently, this information is normally provided through CE (Client Engineer), PIE (Process Integration Engineer) or RA (Reliability Assurance) personnel by email or telephone communication. FIG. 1 illustrates channels by which reliability inquiries are made.

In FIG. 1, a client (customer) has three channels by which to submit reliability inquiries. In channel A, the client contacts the PIE and submits the reliability inquiry via email or telephone communication. After the inquiry is received, the PIE locates the corresponding CS, and forwards it to the RA therethrough. The RA performs a reliability assessment according to the technology level, and returns the result to the client through the CE and PIE manually. In channel B, the client contacts the CE and submits the reliability inquiry, and the CE forwards it to the RA. The RA performs the reliability assessment, and returns the result to the client through the CE. In some rare situations, the client directly, via channel C, contacts the RA, receiving a response immediately.

As shown in FIG. 1, channels of inquiry are complicated. Since there is no integrated channel or solution for reliability assessment, human resource loading for the service supplier or manufacturer is increased, and the process is time-consuming for clients.

Reliability assessment is critical in some specific industries, such as semiconductor industry, since the cost of materials is relatively high. For example, an IC (Integrated Circuit) design house may perform the reliability assessment for its designed products, amending design parameters accordingly before manufacture. Since an IC foundry may have various geometries or unique technology baselines for which there is no effective simulation tool, the assessment results of different RAs may be different, thereby resulting in data inconsistency. It is hard to control and manage delivered data for the service supplier or manufacturer.

### SUMMARY

The present invention is proposed to solve the aforementioned issues. It should be noted that, although this invention is disclosed herein from the perspective of an IC foundry, its concept and spirit are not limited to IC foundries but may be applicable to other factories, service suppliers and products.

Accordingly, it is an object of the present invention to provide a system and method for simulation and assessment of reliability of services or products.

It is another object of the present invention to furnish an integrated business model that enables online reliability assessment.

To achieve the above objects, the present invention provides a reliability assessment system and method. The system, including an interface and assessment engine, is web-based, allowing online reliability assessment. The system receives input items through the interface, and the assessment engine performs the reliability assessment accordingly, generating and displaying the result on the interface.

The interface further receives selections of a process for a product and a corresponding output item, and the assessment engine performs the reliability assessment accordingly, generating the result.

The interface further receives a selection of an assessment item for a product, and the assessment engine performs the reliability assessment for the assessment item accordingly, generating the result of the assessment item.

Input items are received through a web-based interface, allowing online reliability assessment thereby. The reliability assessment is performed accordingly, and a result thereof is generated and displayed on the web-based interface.

Similarly, selections of a process for a product and a corresponding output item are received, and the reliability assessment is performed accordingly, generating the result.

A selection of an assessment item for a product is further received, and the reliability assessment for the assessment item is performed, generating the result thereof.

The above-mentioned method may take the form of program code embodied in a tangible media. When the program code is loaded into and executed by a machine, the machine becomes an apparatus for practicing the invention.

One feature of an embodiment of the present invention is enablement of online reliability assessment without requiring complicated channels and time-consuming processes.

Another feature of an embodiment of the present invention is consistent, fast, efficient, and integrated reliability assessment for clients.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a schematic diagram of a conventional reliability assessment solution;

FIG. 2 is a schematic diagram of the overview of the present invention;

FIG. 3 is a schematic diagram of the system architecture of the reliability assessment system according to the present invention;

FIG. 4 is a schematic diagram of the logic relations of the assessment engine of the reliability assessment system according to the present invention;

FIG. 5 is a flowchart showing the process of the reliability assessment method according to a first embodiment of the present invention;

FIG. 6 is a flowchart showing the process of the reliability assessment method according to a second embodiment of the present invention;

FIG. 7 is an example of an input interface for comprehensive reliability assessment;

FIGS. 8A and 8B are examples of an output interface for comprehensive reliability assessment;

FIG. 9 is an example of an interface for individual reliability assessment;

FIG. 10 is a flowchart showing the process of the reliability assessment method according to a third embodiment of the present invention; and

FIG. 11 is a schematic diagram of a storage medium for storing a computer program providing the reliability assessment method,

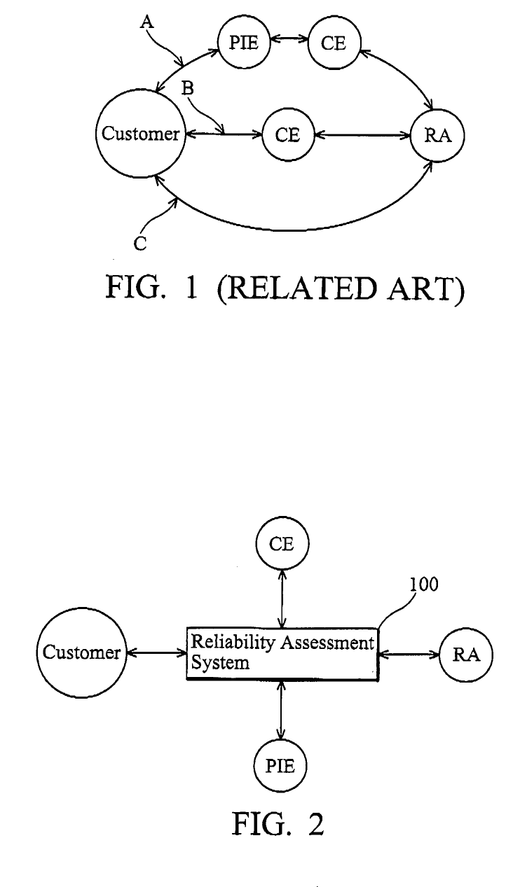

### DESCRIPTION

The present invention provides a system and method overcoming conventional reliability assessment problems.

As will be appreciated by persons skilled in the art from the discussion herein, the present invention has wide applicability to many manufacturers, factories, and industries. For discussion purposes, while disclosed embodiments reference semiconductor foundry manufacturing (i.e., wafer fabrication in an IC foundry), the present invention is not limited thereto.

FIG. 2 is an overview of the present invention. In the present invention, the reliability assessment system 100 provides a web-based reliability assessment for clients via the Internet. In addition, the reliability assessment system 100 also provides access and maintenance via CE, PIE, RA, and related personnel of the service supplier or manufacturer. Process speed, product accuracy, and process reliability are all improved with the present invention.

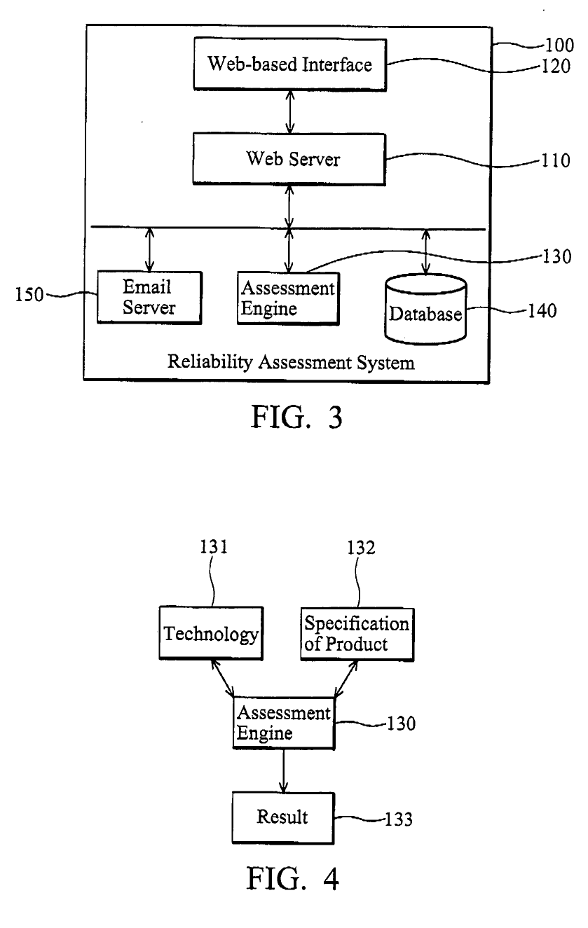

FIG. 3 illustrates the architecture of the reliability assessment system according to the present invention. The reliability assessment system 100 includes a web server 110, an assessment engine 130, a database 140 and an email server 150. The web server 110 provides at least a web-based interface 120, which may be an application program interface (API).

The reliability assessment system 100 receives information (input items), such as reliability inquiries or related data through the web-based interface 120, with the web server 110 forwarding the information to the assessment engine 130, which then performs a reliability assessment according to the information and related functions stored in the database 140. The assessment engine 130 then generates a result for display on the web-based interface 120 via the web server 110.

Further, the assessment engine 130 may write the input information and corresponding result to the database 140. In addition, related personnel can use a maintenance mechanism provided by the system to update the assessment rules and new assessment functions to the database 140. The email server 150 can send an email notification to related personnel if the reliability assessment system 100 receives an assessment request or when results are generated.

FIG. 4 illustrates the logic relations of the assessment engine 130 of the reliability assessment system 100 according to the present invention. For a semiconductor product, the assessment engine 130 receives the technology 131, such as the geometry or generation, and specifications 132 of the product, such as processes employed, including GOI, HCI, NBTI, EM and IMD-TDDB, voltage, temperature, area, transistor size, metal dimension, lifetime, burn-in, die size, and others, performing the reliability assessment accordingly, to generate the result 133.

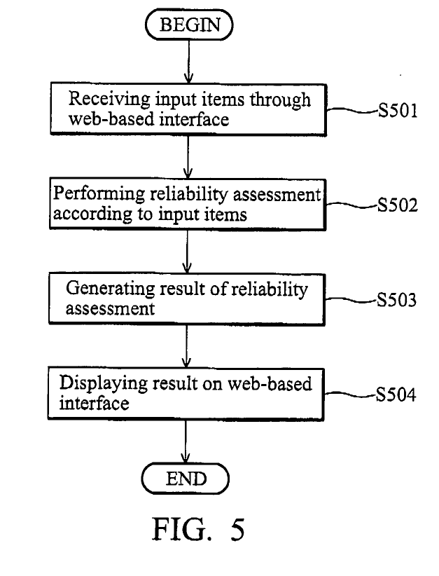

FIG. 5 shows the process of the reliability assessment method according to a first embodiment of the present invention. First, in step S501, input items are received through the web-based interface 120. Then, in step S502, the reliability assessment is performed accordingly, and in step S503, a result of the reliability assessment is generated. Thereafter, in step S504, the result is displayed on the web-based interface 120.

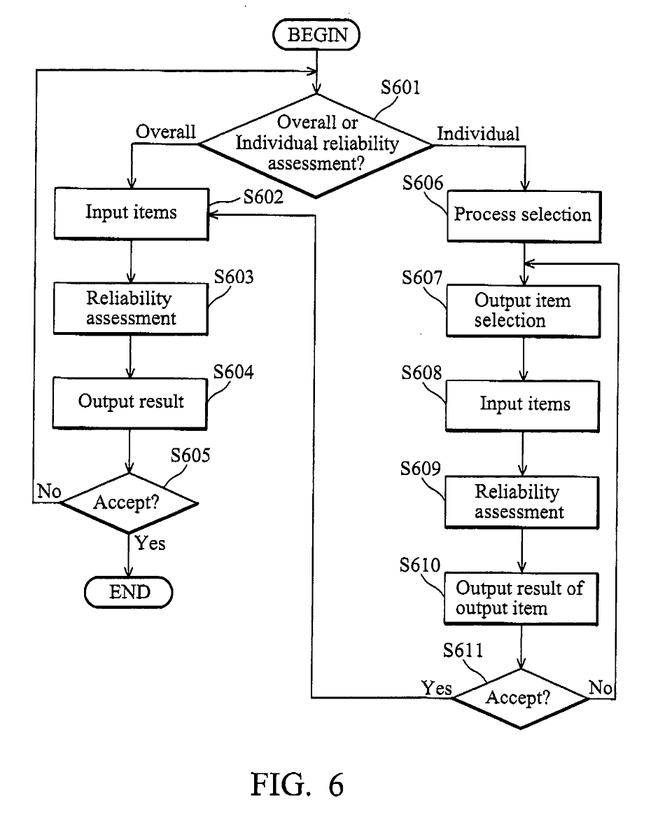

The present invention provides comprehensive, individual and product reliability assessments. FIG. 6 shows the process of the comprehensive (overall) and/or individual reliability assessment method according to a second embodiment of the present invention.

First, in step S601, it is determined whether comprehensive or individual reliability assessment is performed. If comprehensive reliability assessment is selected, in step S602, one page of required input items is displayed on the web-based interface 120, and related information (input items) of a product for comprehensive reliability assessment is input through the web-based interface 120. Then, in step S603, the assessment engine 130 performs the comprehensive reliability assessment for the product accordingly, and in step S604, generates a result of the comprehensive reliability assessment, for subsequent display on a result page of the web-based interface 120.

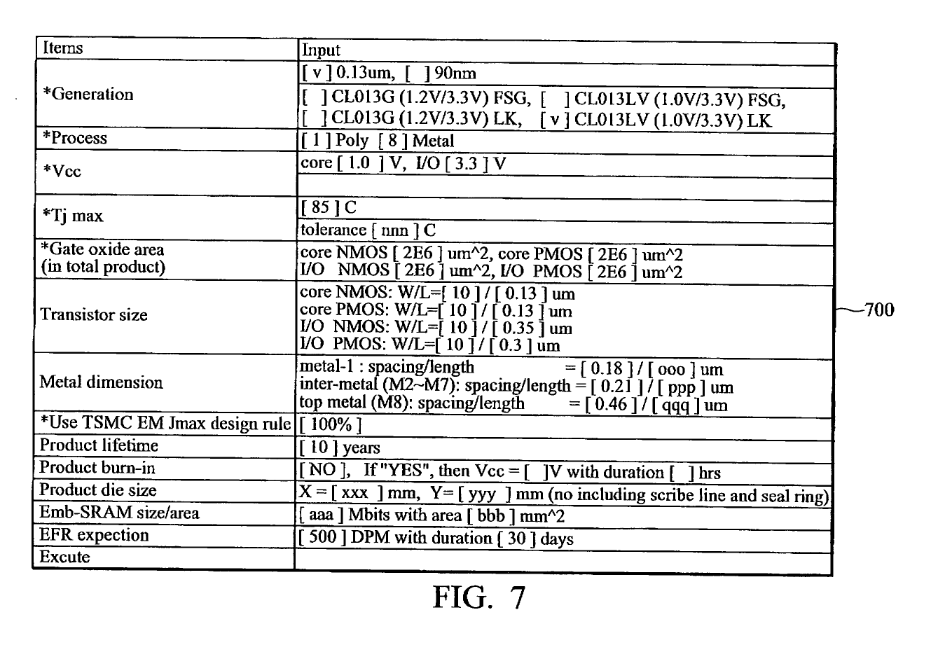

FIG. 7 shows an example of an input interface 700 for comprehensive reliability assessment. The input interface 700 includes an item column including Generation, Process, Vcc, Tj max, Gate oxide area, Transistor size, Metal dimension and others, and an input column corresponding to the item column. The client selects and inputs corresponding input items for respective items.

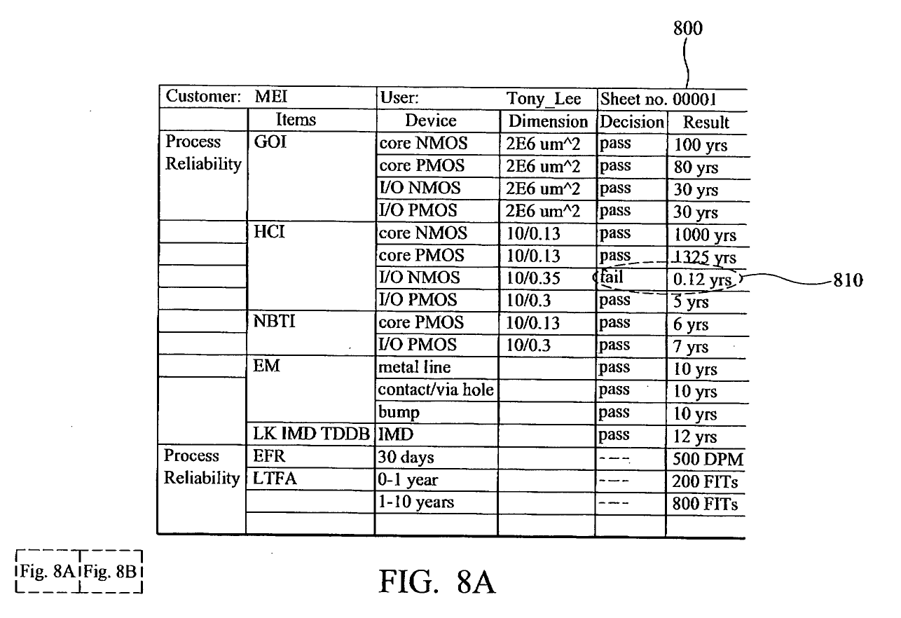

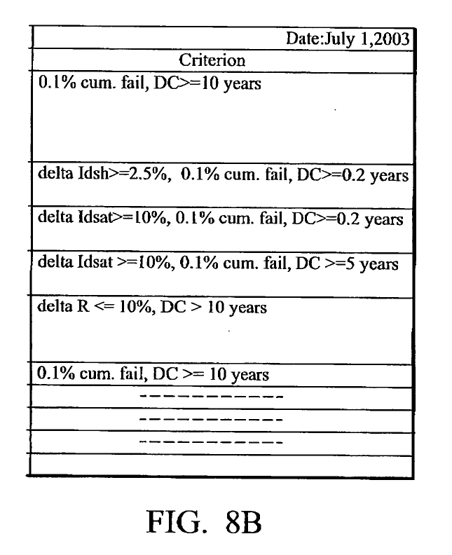

In this example, the generation provided by the system includes CL013G (1.2V/3.3V) FSG representing 0.13 um generic logic with FSG BEOL process and operation voltages of core and I/O are 1.2V and 3.3V, CL013LV (1.0V/3.3V) FSG representing 0.13 um low voltage logic with FSG BEOL process and operation voltages of core and I/O are 1.0V and 3.3V, CL013G (1.2V/3.3V) LK representing 0.13 um generic logic with low-k BEOL process and operation voltages of core and I/O are 1.2V and 3.3V, and CL013LV (1.0V/3.3V) LK representing 0.13 um low voltage logic with low-k BEOL process and operation voltages of core and I/O are 1.0V and 3.3V; Process indicates layers of product design used, Vcc represents voltage on chip, rather than on board, Tj max indicates maximum junction temperature for product design, and Gate oxide area total gate oxide area including core and I/O, NMOS and PMOS gate oxide areas in the product. After the items are input in the input interface 700, the assessment engine 130 performs the comprehensive reliability assessment for the product accordingly, generating and displaying the result on the output interface 800 as shown in FIGS. 8A and 8B. In this example, the result of the comprehensive reliability assessment for the product includes a fail flag 810 in process HCI.

Referring to FIG. 6 again, after the result is generated, in step S605, it is determined whether the result passes the criterion for acceptance by the system. If not (No in step S605), the flow returns to step S601, otherwise, the reliability assessment is completed. On the other hand, if the individual reliability assessment is selected, in step S606, the client selects a process for assessment and, in step S607, one item, such as DC lifetime, transistor size, cum. Fail, Tj max or Vcc, is selected as an output item. In step S608, remaining items without the selected output item are input, and in step S609, the assessment engine 130 performs the individual reliability assessment for the selected process of the product accordingly, and in step S610, generates and displays the result on the web-based interface 120.

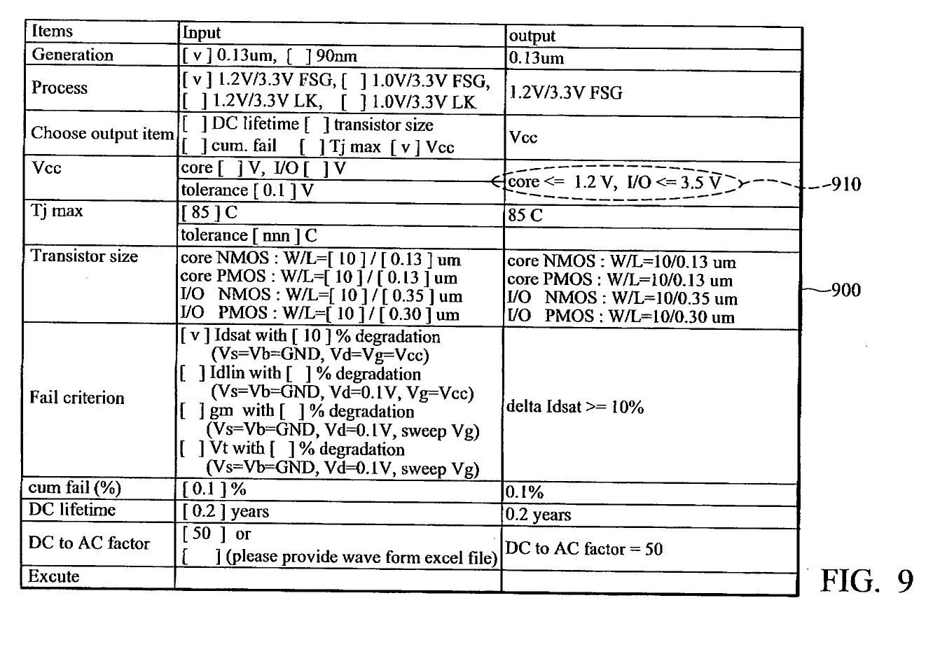

FIG. 9 shows an example of an interface 900 for individual reliability assessment. In this example, since the item Vcc is selected, the result of the item Vcc of the product is displayed on the block 910 for comparison with the product design. If the result is not acceptable (No in step S611), the flow returns to step S607. If accepted, the flow is directed to step S602 for further comprehensive reliability assessment. It should be noted that input items are automatically recorded and entered in the input interface 700.

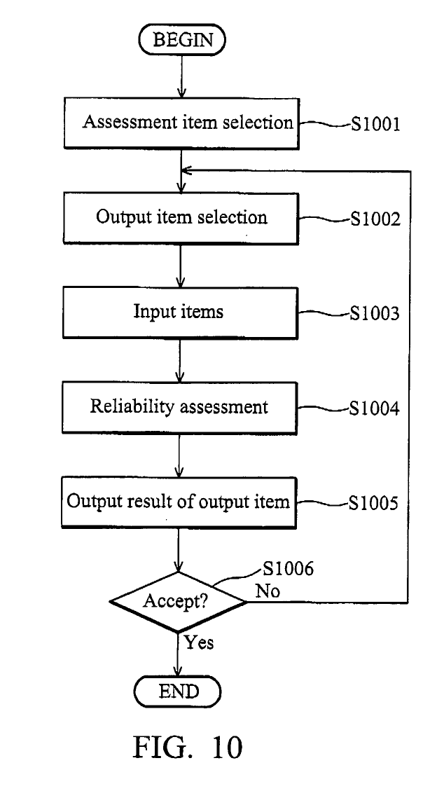

FIG. 10 shows the process of the product reliability assessment according to a third embodiment of the present invention. First, in step S1001, one assessment item, such as EFR (early failure rate), LTFR (long term failure rate), overdrive, overshoot, or temperature of the product is selected for assessment. After the assessment item is selected, in step S1002, one of the items, such as DC lifetime, transistor size, cum. Fail, Tj max, or Vcc is selected as an output item. In step S1003, the client inputs the remaining items without the selected output item. Then, in step S1004, the assessment engine 130 performs the product reliability assessment for the selected assessment item of the product accordingly, and in step S1005, generates and displays a result on the web-based interface 120. Similarly, if the result does not pass the criteria for acceptance by the system (No in step S1006), the flow returns to step S1002 for further simulation. Otherwise (Yes in step S1006), the reliability assessment process is completed.

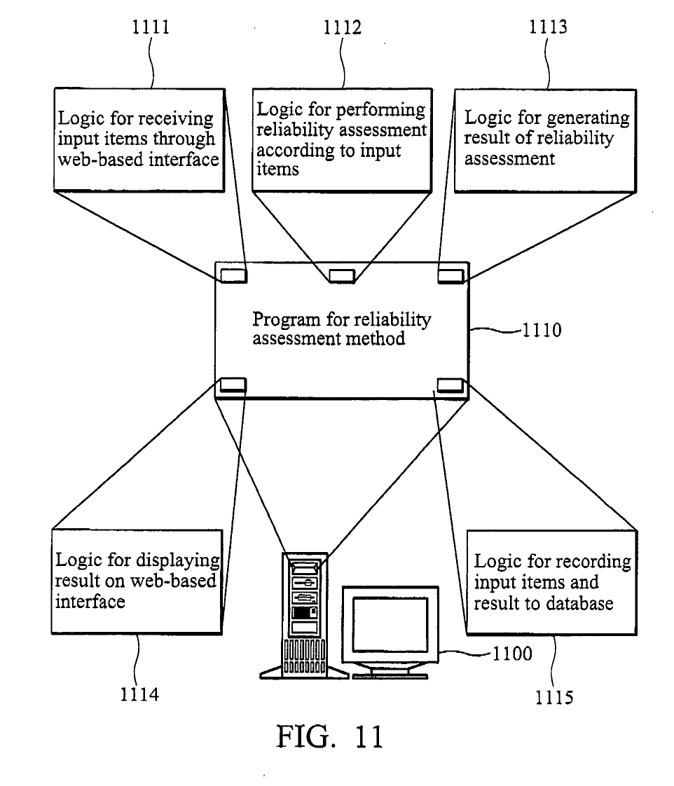

FIG. 11 is a schematic diagram of a storage medium for storing a computer program providing the reliability assessment method according to the present invention. The computer program product comprises a storage medium 1110 having computer readable program codes embodied in the medium for use in a computer system 1100, the computer readable program codes comprising at least a computer readable program code 1111 for receiving input items through a web-based interface, a computer readable program code 1112 for performing reliability assessment according to the input items, a computer readable program code 1113 for generating result of reliability assessment, a computer readable program code 1114 for displaying the result on the web-based interface, and a computer readable program code 1115 for recording the input items and result to the database.

The present invention thus provides a reliability assessment system and method, and a novel business model with integrated channel and online reliability assessment to simulate and assess the reliability of services or product designs, thereby reducing complicated channel communication and time-consuming processes. In addition, the service supplier or manufacturer is provided with systematic mechanisms to provide reliability assessment results, thereby reducing data inconsistency and improving management of delivered data.

The method and system of the present invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The method and systems of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to application specific logic circuits.

Although the present invention has been described in its preferred embodiments, it is not intended to limit the invention to the precise embodiments disclosed herein. Those skilled in this technology can still make various alterations and modifications without departing from the scope and spirit of this invention. Therefore, the scope of the present invention shall be defined and protected by the following claims and their equivalents.

1. A reliability assessment system, comprising:
an interface to receive input items; and
an assessment engine to perform a reliability assessment accordingly, generate a result of the reliability assessment, and display the result on the interface.

2. The system of claim 1 wherein the interface is a web-based interface.

3. The system of claim 1 wherein the assessment engine further writes the input items and the corresponding result to a database.

4. The system of claim 1 further comprising an email server.

5. The system of claim 1 wherein the interface further receives selections of a process for a product and a corresponding output item.

6. The system of claim 5 wherein the assessment engine further performs the reliability assessment accordingly, generating the result.

7. The system of claim 5 wherein the product is a semiconductor product.

8. The system of claim 7 wherein the process comprises GOI, HCI, NBTI, EM or IMD-TDDB.

9. The system of claim 1 wherein the interface further receives a selection of an assessment item for a product.

10. The system of claim 9 wherein the assessment engine further performs the reliability assessment for the assessment item accordingly, generating the result of the assessment item.

11. The system of claim 9 wherein the assessment item comprises EFR (early failure rate), LTFR (long term failure rate), overdrive, overshoot, or temperature of the product.

12. The system of claim 1 wherein the input items comprise technology and specifications of a product.

13. The system of claim 12 wherein the product is a semiconductor product.

14. The system of claim 13 wherein the technology is geometry of the semiconductor product.

15. The system of claim 13 wherein the specification comprises parameters comprising at least a voltage and a lifetime of the semiconductor product.

16. A computerized reliability assessment method, comprising the steps of:
receiving input items through a web-based interface;
performing a reliability assessment accordingly; and
generating a result of the reliability assessment.

17. The method of claim 16 further comprising displaying the result on the web-based interface.

18. The method of claim 16 further comprising writing the input items and the corresponding result to a database.

19. The method of claim 16 further comprising sending an email notification.

20. The method of claim 16 further comprising receiving selections of a process for a product and a corresponding output item through the web-based interface.

21. The method of claim 20 further comprising performing the reliability assessment accordingly, generating the result of the output item.

22. The method of claim 20 wherein the product is a semiconductor product.

23. The method of claim 22 wherein the process comprises GOI, HCI, NBTI, EM or IMD-TDDB.

24. The method of claim 16 further comprising receiving a selection of an assessment item for a product through the web-based interface.

25. The method of claim 24 further comprising performing the reliability assessment for the assessment item accordingly, generating the result of the assessment item.

26. The method of claim 24 wherein the assessment item comprises EFR (early failure rate), LTFR (long term failure rate), overdrive, overshoot, or temperature of the product.

27. The method of claim 16 wherein the input items comprise technology and specifications of a product.

28. The method of claim 27 wherein the product is a semiconductor product.

29. The method of claim 28 wherein the technology is geometry of the semiconductor product.

30. The method of claim 28 wherein the specification comprises parameters comprising at least a voltage and a lifetime of the semiconductor product.

31. A machine-readable storage medium storing a computer program which, when executed, directs a computer to perform a method of reliability assessment, comprising the steps of:
receiving input items through a web-based interface;
performing a reliability assessment accordingly; and
generating a result of the reliability assessment.

32. The storage medium of claim 31 further comprising displaying the result on the web-based interface.

33. The storage medium of claim 31 further comprising writing the input items and the corresponding result to a database.

34. The storage medium of claim 31 further comprising sending an email notification.

35. The storage medium of claim 31 further comprising receiving selections of a process for a product and a corresponding output item through the web-based interface.

36. The storage medium of claim 35 further comprising performing the reliability assessment accordingly, generating the result of the output item.

37. The storage medium of claim 35 wherein the product is a semiconductor product.

38. The storage medium of claim 37 wherein the process comprises GOI, HCI, NBTI, EM or IMD-TDDB.

39. The storage medium of claim 31 further comprising receiving a selection of an assessment item for a product through the web-based interface.

40. The storage medium of claim 39 further comprising performing the reliability assessment for the assessment item accordingly, generating the result of the assessment item.

41. The storage medium of claim 39 wherein the assessment item comprises EFR (early failure rate), LTFR (long term failure rate), overdrive, overshoot, or temperature of the product.

42. The storage medium of claim 31 wherein the input items comprise technology and specifications of a product.

43. The storage medium of claim 42 wherein the product is a semiconductor product.

44. The storage medium of claim 43 wherein the technology is geometry of the semiconductor product.

45. The storage medium of claim 43 wherein the specification comprises parameters further comprising at least a voltage and a lifetime of the semiconductor product.

46. A reliability assessment method, comprising the steps of:
providing an online reliability assessment of a reliability inquiry via a web-based interface; and
generating a result of the reliability assessment on the web-based interface.

47. The method of claim 46 further comprising receiving input items for the reliability assessment, in which the result of the reliability assessment is generated accordingly.

48. The method of claim 46 further comprising receiving selections of a process for a product and a corresponding output item through the web-based interface.

49. The method of claim 48 further comprising performing the reliability assessment accordingly, generating the result of the output item on the web-based interface.

50. The method of claim 46 further comprising receiving a selection of an assessment item for a product through the web-based interface.

51. The method of claim 50 further comprising performing the reliability assessment for the assessment item accordingly, generating the result of the assessment item on the web-based interface.

52. The method of claim 50 wherein the assessment item comprises EFR (early failure rate), LTFR (long term failure rate), overdrive, overshoot, or temperature of the product.

53. A set of application program interfaces embodied on a computer-readable medium for execution on a computer in conjunction with an application program that performs a reliability assessment, comprising:
a first interface to receive input items of a reliability inquiry; and
a second interface to display a result of the reliability assessment, in which the result is generated accordingly.

54. The set of application program interfaces of claim 53 further comprising a third interface to receive selections of a process for a product and a corresponding output item, in which the reliability assessment is performed accordingly.

55. The set of application program interfaces of claim 53 further comprising a fourth interface to receive a selection of an assessment item for a product, in which the reliability assessment for the assessment item is performed accordingly.
